(19) United States
(12) Patent Application Publication
(10) Pub. No.: US 2005/0042025 A1
(43) Pub. Date: Feb. 24, 2005

(54) Work tool locking device

(76) Inventors: Darin R. Miller, Wamego, KS (US); Gregory A. Seljestad, Wamego, KS (US); Collin M. Spellmeier, Wamego, KS (US)

Correspondence Address: CATERPILLAR INC.;100 N.E. ADAMS STREET, PATENT DEPT., PEORIA, IL, 616296490, US

(21) Appl. No.: 10/956,552

(22) Filed: Oct. 1, 2004

Related U.S. Application Data
(63) Continuation of application No. 09/906,477, filed on Jul. 16, 2001, now abandoned.

(51) Int. Cl. B25G 3/18

(52) U.S. Cl. 403/322.2

(57) ABSTRACT

In the operation of a work machine of the type having an attachment having more than one implement, it is oftentimes desirable or necessary to operate one implement to the exclusion of the other requiring the operator to manually chain, bolt, or otherwise secure the non-used implement to the work machine. The present invention provides a locking device for use with a work machine which includes a base portion for attachment to the work machine, an engagement member rotatably coupled to the base portion, a receiving portion attached to the engagement portion and a latching mechanism constructed and arranged to maintain the engagement member in a fixed position, relative to the base portion, when the latching mechanism is in a latched position.

This application is a continuation of U.S. patent application Ser. No. 09/906,477, filed Jul. 16, 2001, now abandoned.

### TECHNICAL FIELD

This invention relates to a work tool-locking device and, more specifically, to a work tool-locking device for releasably maintaining a work tool against the body of a work machine when not in use.

### BACKGROUND

Work machines may typically have operable work tools or attachments such as buckets, grapples or the like connected therewith.

Oftentimes, an attachment may consist of two implements such as, for example, a bucket and thumb each of which may be individually operated to effectuate the desired operation. Oftentimes, it is desirable or necessary to operate one implement to the exclusion of the other. This may arise, for example, in trenching operations in which it is desirable to use the bucket without the thumb.

In order to prevent inadvertent movement of the non-used implement, which may interfere with the operations being performed, it is oftentimes necessary for the operator to exit the operator station and chain, bolt, or otherwise secure the non-used implement to the work machine.

### BREIF DESCRIPTION OF THE DRAWINGS

FIG. 1 is a diagrammatic side elevation view of a work machine embodying the principals of the present invention.

FIG. 2 is a diagrammatic side elevation view showing one implement in a latched position.

FIG. 3 is a diagrammatic view of a locking device of the present invention.

FIG. 4 is diagrammatic cross-sectional view, taken through section 4-4 in FIG. 3, of the locking device of FIG. 3.

### DETAILED DESCRIPTION

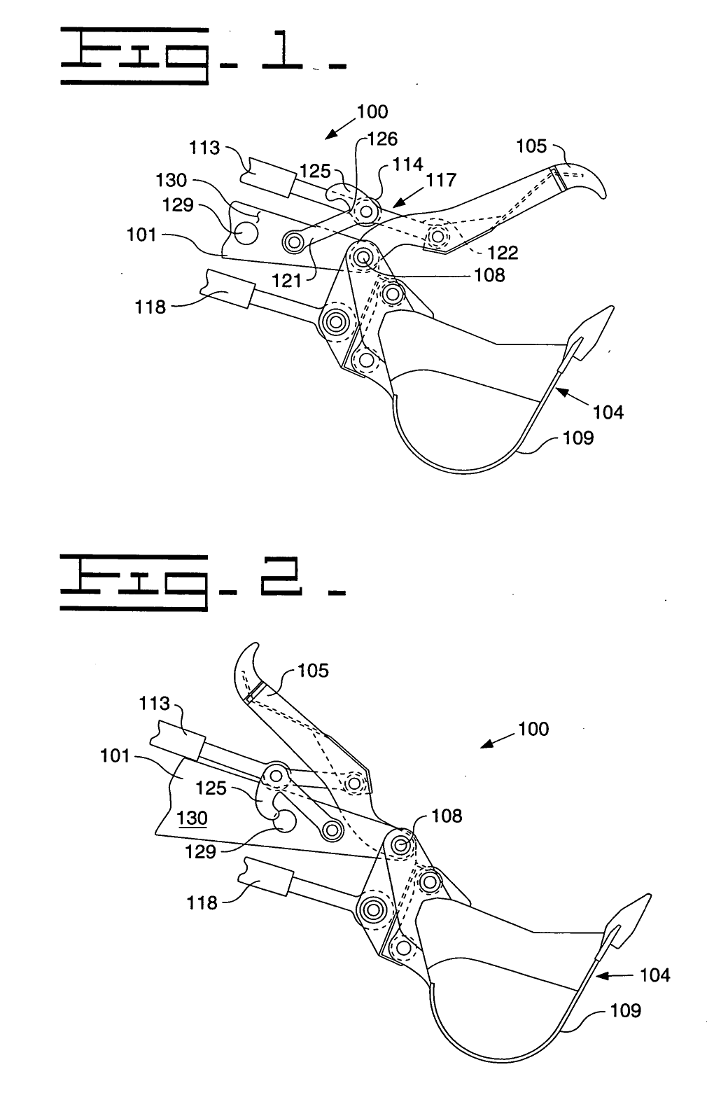

With reference now to the Figures, shown in FIGS. 1 and 2 is a portion of a work machine 100 of the type having a stick 101 on which is pivotally mounted an attachment 104. The attachment 104, in turn, comprises a first implement part 105 which is pivotable, relative to the stick 101, about pin 108. Also shown is a second implement part 109 which may also be pivotable, relative to the stick 101, about pin 108. For purposes of illustration and not limitation the first and second implement parts 105, 109 will be illustrated and described herein as, respectively, a thumb and a bucket. However, such a showing is exemplary only and it is contemplated that other types of implements may also be used without deviating from the spirit of the present invention. A first motor, preferably a hydraulic cylinder 113, is coupled at its end 114 to the first implement part 105 by use of a linkage assembly 117 and is actuatable to position the first implement part 105 relative to the stick 101. In addition, a second motor, also preferably a hydraulic cylinder 118, is coupled to the second implement part 109 and is actuatable to position the second implement part 109 relative to the stick 101.

Linkage assembly 117 comprises a first linkage 121 extending between, and thereby coupling, the stick 101 and the first hydraulic cylinder 113, and a second linkage 122, which couples the first hydraulic cylinder 113 to the first implement part 105. A catch member 125 is attached, preferably integrally, to an end 126 of the first linkage 121 and is used to engage a locking device 129 which is attached to the body 130 of the work machine 100, preferably the stick 101. However, it is to be understood that such a showing is exemplary only and other attachment locations are contemplated such as, for example, on the attachment 104 or linkage assembly 117. Although the details of the locking device 129 will be described more fully as this disclosure progresses, suffice to say for now, the locking device 129 advantageously maintains the first implement part 105 in a stationary position when it is desirable to only use the second implement part 109, and the first implement part 105 would otherwise interfere with efficient use of the second implement part 109 if not held in place. It is to be understood that the attachment of the catch member 125 to the first linkage 121 is exemplary only and that other attachment locations for the catch member 125 may be used such as, for example, the first hydraulic cylinder 113 or the first implement part 105.

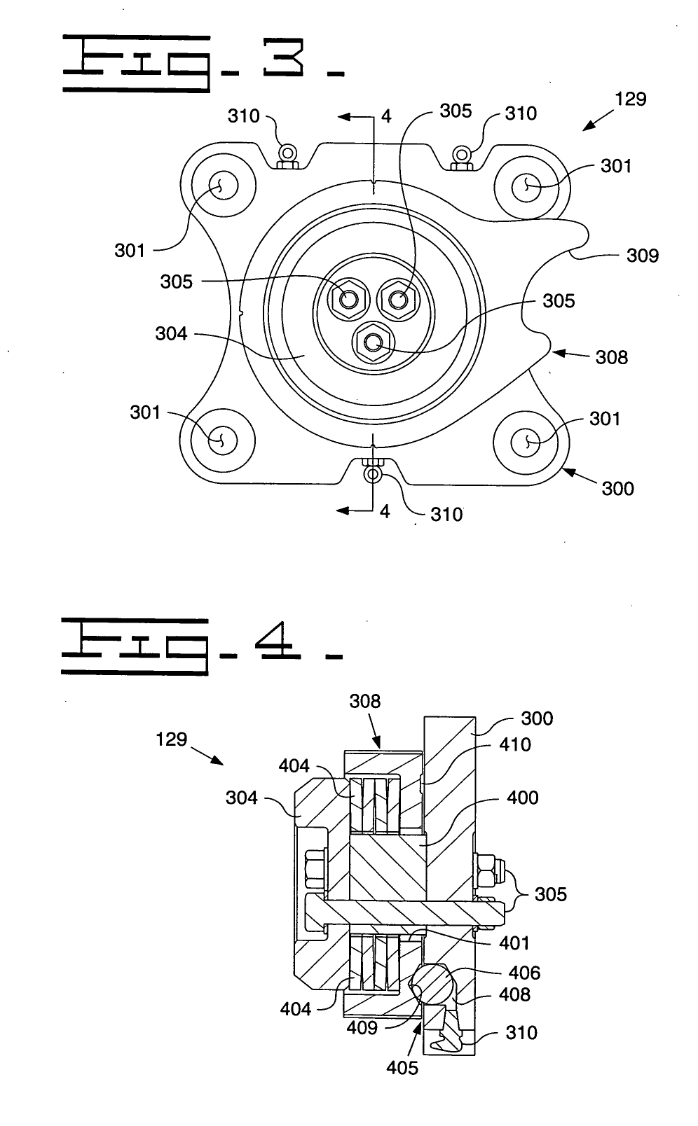

With reference to FIGS. 3 and 4, the details of the locking device 129 will now be discussed. The locking device 129 includes a base portion 300 having preferably four openings 301 for receiving fasteners (not shown), which are used to couple the base portion 300 to either the stick 101 or to a separate boss (not shown), which may be integrally attached to the stick 101. A retaining member 304 is coupled to the base portion 300 preferably by use of fasteners 305. An engagement member 308 is rotatably coupled with the base portion 300 and includes a receiving portion 309 for receiving the catch member 125. Also shown are grease fittings 310, which are used to facilitate lubrication of the locking device 129.

With reference to the FIG. 4 cross-sectional view, the retaining member 304 is spaced apart from the base portion 300 by use of a spacer 400, which is concentrically placed within an opening 401 provided in the engagement member 308. Biasing members 404, preferably comprising springs, are placed between the engagement member 308 and the retaining member 304 and are used to bias or urge the engagement member 308 towards the base portion 300. Although the aforementioned use of the springs for the biasing members 404 are the preferred means to urge the engagement member 308 towards to the base portion 300, it is also contemplated that other means may be used as well such as placing an elastomeric member or members between the retaining member 304 and the base portion 300. As used herein, “elastomeric member” refers to those materials that are able to compress and then substantially expand to their pre-compressed shape.

The locking device 129 further includes a latching mechanism, which is shown generally at 405. The latching mechanism 405 comprises a plurality of bodies 406 (one shown), preferably comprising ball bearings, each placed within a corresponding pocket 408 formed in the base portion 300. The bodies 406, in turn, engage a corresponding indentation 409 (one shown) provided in the engagement member 308 when the locking device 129 is in a latched position. As used herein, “latched position” refers to that configuration of the locking device 129 in which the indentations 409 engage the bodies 406.

The engagement member 308 may be provided with a groove 410, which operates as a guide for the bodies 406 so as to maintain the engagement member 308 in a fixed, centered position. Also as shown, the grease fittings 310 are in communication with the pockets 408 and are used to channel an external source of lubrication to the ball bearings or bodies 406.

Although not shown, other alternative arrangements for the latching mechanism 405 may also be used such as, for example, instead of using a separate body 406, providing a fixed protrusion (not shown) on the engagement member 308 to engage the pocket 408 on the base portion 300, or providing the fixed protrusion on the base portion 300 to engage the indentation 409 on the engagement members 308.

Industrial Applicability

In use and in operation, the locking device 129 of the present invention allows one implement part of at least a two-implement attachment to be stowed-away while the other implement part is being used. With reference to the Figures, actuation of the first hydraulic cylinder 113 in such a manner as to cause the first implement part 105 to rotate in a first or counter-clockwise direction (e.g., away from the second implement part 109) causes the catch member 125 to engage the receiving portion 309. Continued actuation of the first hydraulic cylinder 113 causes the engagement member 308 to rotate, relative to the base portion 300, until the indentations 409 provided on the engagement member 308 engage the ball bearings or bodies 406, at which point the locking device 129 is in a latched position. As should be appreciated by those of ordinary skill in such art, when in the aforementioned latched position, the first implement part 105 is prevented from “drifting” or otherwise moving from the latched position while the second implement part 109 is being used without the need for the operator to exit the operator station and manually secure the first implement part 105 to the stick 101.

Releasing the first implement part 105 from the locking device 129 consists of simply actuating the first hydraulic cylinder 113 in such a manner as to cause the first implement part 105 to rotate in a second or clockwise direction (e.g., towards the second implement part 109). When sufficient hydraulic pressure has accumulated in the first hydraulic cylinder 113, the engagement member 308 is forced to rotate against the force of the biasing members 404 thereby disengaging the indentations 409 from the bodies 406 and releasing the first implement part 105. Each of the biasing members 404 may be suitably selected from one of ordinary skill in such art such that the locking device 129 can only be placed in the unlatched state when a sufficient amount of hydraulic pressure has accumulated in the first hydraulic cylinder 113. As used herein “unlatched position” refers to that position in which the indentations 409 are disengaged from the bodies 406. In addition, a switch-type mechanism (not shown) is also contemplated to unlatch the locking device 129. The switch-type mechanism may comprise a mechanical, electrical, hydro-electrical, electro-mechanical or other type of switch, which may be actuated from the operator's station and coupled to the locking device 129 in a manner readily apparent to those of ordinary skill in such art.

Other aspects, objects and advantages of this invention can be obtained from a study of the drawings, the disclosure and the appended claims.

1. A locking arrangement for an implement of a work machine, comprising:
a work machine having a body;
at least one implement pivotally coupled to said work machine;
a motor coupled to said implement;
a catch member coupled with one of said implement or said body; and
a locking device attached to the other of said implement or said body, for receiving said catch member.

2. The locking arrangement as set forth in claim 1 wherein said locking device comprises:
a base portion constructed and arranged for attachment to said work machine;
an engagement member rotatably coupled to said base portion;
a receiving portion attached to said engagement member; and
a latching mechanism constructed and arranged to maintain the engagement member in a fixed position, relative to the work machine, when said latching mechanism is an a latched position.

3. The locking arrangement as set forth in claim 2 further comprising:
a retaining member coupled with said base portion; and
a biasing member placed between said retaining member and said engagement member for biasing said engagement member towards said base portion.

4. The locking arrangement as set forth in claim 1 further comprising:
a linkage assembly coupling said hydraulic cylinder to said body; and
wherein said catch member is attached to said linkage assembly.

5. The locking arrangement as set forth in claim 1 wherein at least one of said implements is thumb.

6. The locking arrangement as set forth in claim 1 wherein said motor is a hydraulic cylinder.

7. A method of remotely preventing inadvertent rotation of an implement relative to a work machine, the implement being movable by a hydraulic cylinder, comprising the steps of:
providing the work machine with a locking device including:
an engagement member rotatably coupled to said work machine;
a receiving portion attached to said engagement member; and
a latching mechanism constructed and arranged to maintain the engagement member in a fixed position, relative to the work machine, when said latching mechanism is an a latched position;
providing the work machine with a catch member;
actuating the hydraulic cylinder in such a manner as to cause said catch member to engage said receiving portion; and
continuing to actuate the hydraulic cylinder thereby causing said engagement member to rotate in a first direction until said latching mechanism is in a latched position.

8. The method of claim 7 further including the step of actuating the hydraulic cylinder in such a manner as to cause said engagement member to rotate in a second direction until said latching mechanism is in an unlatched position.

9. The method of claim 7 further including the step of providing a switch mechanism coupled to the catch member for use in placing said latching mechanism in an unlatched position.

10. A work machine with a latching arrangement for releasably latching an implement to the work machine, the work machine comprising:
a body;
an implement-linkage assembly mounted to the body;
a first motor exerting a force on the implement-linkage assembly in first and second directions to cause the implement-linkage assembly to move relative to the body to perform a work operation;
one of a catch member or a locking device mounted to the implement-linkage assembly;
the other of a catch member or a locking device mounted to the body;
wherein the motor exerts a force on the implement-linkage assembly in the first direction to move the catch member into latching engagement with the locking device, the latching engagement being maintained until the first motor exerts a force in the second direction on the implement-linkage assembly sufficient to de-latch the catch member and locking device.

11. A work machine according to claim 10 wherein the implement-linkage assembly comprises:
a first implement pivotally mounted to the body;
a linkage assembly operatively connecting the first motor to the first implement;
a second implement pivotally mounted to the body; and
wherein the second implement can be pivoted relative to the body when the catch member and locking device are latched, and the first implement cannot be pivoted relative to the body when the catch member and locking device are latched.

12. A work machine according to claim 10, wherein the body further comprises:
an elongated stick, the stick being pivotably movable relative to the work machine under the force of a hydraulic cylinder during performance of a work operation; and
wherein the implement-linkage assembly is mounted to the stick.

13. A work machine according to claim 12 wherein the first motor is a hydraulic cylinder.

14. A work machine according to claim 12 wherein the implement-linkage assembly comprises:
a first implement pivotally mounted to the stick; and
a linkage assembly operatively connecting the first motor to the first implement.

15. A work machine according to claim 14 wherein the implement-linkage assembly further comprises:
a second implement pivotally mounted to the stick; and
wherein the second implement can be pivoted relative to the stick when the catch member and locking device are latched, and the first implement cannot be pivoted relative to the stick when the catch member and locking device are latched.

16. A work machine according to claim 15 wherein the first implement is a thumb and the second implement is a bucket, the thumb cooperating with the bucket to perform a work operation.

17. A work machine according to claim 16 wherein the locking device comprises:
a base portion constructed and arranged for attachment to one of the body or the implement-linkage assembly;
an engagement member rotatably coupled to the base portion;
a receiving portion attached to the engagement member; and
a latching mechanism operatively engaging the base portion and the engagement member to maintain the engagement member in a fixed radial position relative to the base portion when the latching mechanism is an a latched position.

18. A work machine according to claim 10 wherein the locking device comprises:
a base portion constructed and arranged for attachment to one of the body or the implement-linkage assembly;
an engagement member rotatably coupled to the base portion;
a receiving portion attached to the engagement member; and
a latching mechanism operatively engaging the base portion and the engagement member to maintain the engagement member in a fixed radial position relative to the base portion when the latching mechanism is an a latched position.

19. A method of releasably latching a first implement of a work machine to the work machine to prevent unintended movement of the first implement relative to the work machine, the work machine comprising:
an implement-linkage assembly comprising a first implement and a linkage assembly operationally associated with the first implement; and
a first motor operationally associated with the implement-linkage assembly;
the method comprising:
moving the implement-linkage assembly relative to the work machine through a force applied to the implement-linkage assembly by the first motor to perform a work operation;
moving the implement-linkage assembly to a first position relative to the work machine through a force applied to the implement-linkage assembly by the first motor, a catch member attached to one of the work machine or the implement-linkage assembly latching to a locking device mounted to the other of the work machine or the implement-linkage assembly when the implement-linkage assembly is in the first position; and
the catch member and the locking device holding the implement-linkage assembly in the first position until a sufficiently large force is applied to the implement-linkage assembly by the first motor to de-latch the catch member and the locking device.

20. A method according to claim 19 wherein the implement-linkage assembly further comprises:
a second implement, the first and the second implement each being pivotally mounted to a body;
wherein the method further comprises:
moving the second implement relative to the body by a force applied to the second implement from a hydraulic cylinder to perform a work operation while the catch member and the locking device are latched.
